(19) United States
(12) Patent Application Publication
(10) Pub. No.: US 2023/0347584 A1
(43) Pub. Date: Nov. 2, 2023

(54) THERMOSETTING COMPOSITE MATERIAL AND ASSOCIATED PRINTING METHOD

(71) Applicants: INSTITUT POLYTECHNIQUE DE GRENOBLE, Grenoble (FR); CENTRE NATIONAL DE LA RECHERCHE SCIENTIFIQUE, Paris (FR)

(72) Inventors: David BENEVENTI, Saint Martin D'Heres (FR); Didier CHAUSSY, Brie et Angonnes (FR); Khaoula BOUZIDI, Grenoble (FR); Alessandro GANDINI, Saint Martin D'Uriage (FR)

(21) Appl. No.: 17/794,948

(22) PCT Filed: Jan. 26, 2021
(86) PCT No.: PCT/EP2021/051761

§ 371 Date: Jul. 22, 2022

(30) Foreign Application Priority Data
Jan. 28, 2020 (FR) FR2000807

(51) Int. Cl. B29C 64/165; B33Y 70/00; B33Y 10/00

(52) U.S. Cl. CPC B29C 64/165; B33Y 70/00; B33Y 10/00; B29K 2401/00

(57) ABSTRACT

A thermosetting composite material and its method for 3D printing by extrusion, the thermosetting composite material including a furan polymer forming a thermosetting matrix, a solvent, and a material formed from particles chosen from among micrometric particles, nanometric particles, even a mixture of micrometric particles and nanometric particles, these particles being with the basis of a compound comprising more than 40% by mass of carbon. The thermosetting composite material and its 3D printing method enabling to obtain an object having dimensional tolerances of between 2.5 and 5% with respect to the numerical model, and a resistance to high temperatures going up to 300° C. The thermosetting composite material and its 3D printing method representing a biosourced and cheaper alternative with respect to synthetic thermoplastic polymers and their usual printing method.

### TECHNICAL FIELD

The present invention relates to the field of thermosetting composite materials. It has a particularly advantageous application in the field of three-dimensional printing (below, abbreviated to 3D) by extrusion of objects resistant to high temperatures.

### STATE OF THE ART

Thermoplastic polymers such as polyetheretherketone (abbreviated to PEEK), polyetherimide (abbreviated to PEI) and polyphenylsulfone (abbreviated to PPSF) are the main materials used for the 3D printing of objects resistant to high temperatures. More specifically, these polymers are deposited by fused deposition modelling methods (abbreviated to FDM).

PEEK, PEI and PPSF are however expensive synthetic thermoplastic polymers, typically of between €250 and €600 per kg. These polymers further require very restrictive printing thermal conditions. Typically, the printing nozzles are maintained at temperatures of between 350° C. and 400° C., and the temperature of the printing bed is of between 150° C. and 180° C. The temperature of the printing chamber is preferably homogenous and of between 130° C. and 160° C., otherwise the object risks undergoing deformations and/or delaminations during printing, in particular when the object is of an average size, the dimensions of which are, for example, around 5×5×5 cm, when large, the dimensions of which are, for example, around 25×25×25 cm. The deformation and delamination phenomena can, in particular, lead to a deterioration of the quality and of the mechanical properties of the printed object.

Generally, the 3D printing of objects with these polymers require an annealing to relax the internal constraints and avoid the cracking of the printed object. These polymers have close mechanical properties, with elastic modules of around 3 to 8 GPa and vitreous transition temperatures of between 160° C. and 220° C. Beyond their vitreous transition temperature, the elastic properties of these polymers however start to degrade progressively, which can deteriorate the quality of the object, and in particular the shape of the object obtained from the annealing.

Alternative 3D printing technologies, using other materials, can be used. In particular, the sintering of powder and the spraying of binder, with metal- and ceramic-based materials, can be used to manufacture objects which are resistant to high temperatures.

Powder sintering techniques however require specific printing machines, five to fifty times more expensive than machines based on polymer extrusion. Controlling the composition of the final composite material remains difficult. Furthermore, the parts developed must generally be dust-free.

An aim of the present invention is therefore to propose an alternative to synthetic thermoplastic polymers, for the development of objects and more specifically, for the development of objects which are resistant to high temperatures. A non-limiting aim of the invention can further be to propose a biosourced alternative to synthetic thermoplastic polymers. A non-limiting aim of the invention can further be to propose a thermosetting composite material enabling the development of composite objects by 3D printing, and more specifically, by 3D printing by extrusion.

Another aim can be to propose a biosourced thermosetting composite material enabling the development of objects made of composite material by 3D printing by extrusion. Another aim of the present invention can be to propose a thermosetting composite material enabling the development by 3D printing by extrusion, of objects made of composite material having good heat-resistant properties. Another aim of the present invention can be to reduce the costs of a method for developing objects made of a composite material by 3D printing by extrusion, and in particular, of objects made of a composite material having good heat-resistant properties.

Other aims, characteristics and advantages of the present invention will appear upon examining the following description and the accompanying drawings. It is understood that other advantages can be incorporated.

### SUMMARY

To achieve this aim, according to a first aspect, a thermosetting composite material is provided, comprising:
a furan polymer forming a thermosetting matrix of the composite material, and
a non-miscible material with the thermosetting matrix.

The thermosetting composite material is characterised in that it further comprises a solvent, and in that the non-miscible material with the thermosetting matrix is formed of particles chosen from among micrometric particles, nanometric particles, even a mixture of micrometric particles and of nanometric particles, these particles being with the basis of a compound comprising more than 40% by mass of carbon.

According to another aspect, the invention relates to a thermosetting composite material for 3D printing by extrusion, the material being mainly such as introduced above.

According to an example, the particles which form the non-miscible material with the thermosetting matrix are only constituted of a compound comprising more than 40% by mass of carbon.

The non-miscible material with the thermosetting matrix in the form of micrometric particles, even nanometric, enables to preserve, even to improve the heat-resistant properties of a furan resin, while conferring rheological properties to the thermosetting composite material, and in particular in terms of viscosity, of shear-thinning and thixotropic behaviour. Moreover, the mechanical properties of the composite material formed can be improved.

This thermosetting composite material thus represents a biosourced alternative to synthetic thermoplastic polymers, for the development of objects which are resistant to high temperatures.

The dimensions of the non-miscible material with the thermosetting matrix enabling printing by extrusion of the material by minimising, even avoiding, the risk of printing nozzles blocking, during a 3D printing of an object. Preferably, the particles of the non-miscible material with the thermosetting matrix are not integral, for example they are not bonded together by micrometric fibres. Synergistically, the presence of the solvent in the thermosetting composite material facilitates its printing by extrusion. The method thus enables to develop composite objects by 3D printing, and more specifically, by 3D printing by extrusion, these objects further have heat-resistant properties.

A second aspect of the invention relates to a use of the thermosetting composite material for 3D printing by extrusion.

A third aspect of the invention relates to a method for 3D printing of an object, comprising:
an extrusion of a thermosetting composite material comprising a furan polymer, the furan polymer forming a thermosetting matrix of the thermosetting composite material, a solvent, and a non-miscible material with the thermosetting matrix, the non-miscible material with the thermosetting matrix being formed of particles chosen from among micrometric particles, nanometric particles, even a mixture of micrometric particles and nanometric particles, these particles being with the basis of a compound comprising more than 40% by mass of carbon, the thermosetting composite material being extruded at an extrusion temperature greater than or equal to ambient temperature and less than the cross-linking temperature of the furan polymer, and
a heat treatment comprising an annealing of the extruded thermosetting composite material, at an annealing temperature greater than or equal to the cross-linking temperature of the furan polymer, so as to induce an at least partial cross-linking of the thermosetting matrix to form an object made of a composite material comprising an at least partially cross-linked matrix.

In this method, the thermosetting composite material is extruded by paste extrusion (also called LDM (liquid deposition modelling)). The thermosetting composite material is printed without having to be in the molten state, thanks to its adapted rheological properties, and in particular in terms of viscosity, shear-thinning and thixotropic behaviour. The shape of the printed object is not fixed by a phase change, and more specifically by solidification, but it is fixed by the instantaneous reestablishment after extrusion of the viscosity of the thermosetting composite material below its flow threshold, and the cross-linking of the thermosetting matrix of the composite material. This method thus enables to decrease the delamination and deformation phenomena with respect to current solutions, wherein a significant removal of thermoplastic polymers occurs during cooling, and in particular during the phase change of the polymers after their deposition in the molten state.

It has further been demonstrated during the development of the method, that the final object has dimensional tolerances of between 2.5 and 8%, even between 2.5 and 5% with respect to the numerical model, and a resistance to high temperatures going up to 300° C. without degradation of the composite material.

Moreover, the extrusion temperature is less than the fused deposition temperature of the current solutions. The cost of the thermosetting composite material is further twenty to sixty times less with respect to that of synthetic polymers. The cost of the method is decreased with respect to the current solutions.

The printing of objects which are resistant to high temperatures is thus reliably permitted, with a biosourced material and with a reduced cost with respect to the current solutions. The method further has the advantage of being simplified and of having a lower cost compared with the powder sintering or binder jet method.

Optionally, the thermosetting composite material can further have at least any one of the following optional characteristics, which can possibly be used in association or alternatively:
the particles can comprise at least some from among carbon particles, such as graphite particles, carbon black particles, graphene particles, carbon nanotubes and/or carbon nanofibres, and particles with the basis of one from among cellulose, sawdust, and fruit pips or shells,
when the particles are cellulose-based, the proportion of particles in the thermosetting composite material can be of between 15% and 40% by mass, preferably between 20% and 35%, and more preferably, between 25% and 30%, with respect to the total mass of the composite material,
when the particles are with the basis of one from among sawdust, and fruit pips or shells, the proportion of particles in the thermosetting composite material can be of between 10% and 80% by mass, preferably between 15% and 60%, and more preferably, between 20% and 40%, with respect to the total mass of the composite material,
when the particles are carbon particles, the proportion of particles in the thermosetting composite material can be of between 1% and 80% by mass, preferably between 10% and 70%, and more preferably between 40% and 60%, with respect to the total mass of the composite material,
the proportion of the solvent in the thermosetting composite material can be of between 5% and 25% by mass, preferably between 10% and 20%, with respect to the total mass of the composite material,
the solvent can have at least one from among a boiling point of less than 150° C. and a flashpoint temperature greater than 50° C.,
the solvent can be chosen from among water, ethanol, isopropanol and a mixture of at least two from among water, ethanol and isopropanol,
the proportion of furan polymer in the thermosetting composite material can be greater than 20% by mass, preferably the proportion of furan polymer is of between 50% and 70% by mass, with respect to the total mass of the composite material,
the furan polymer can have a polymerisation degree of less than 10. Preferably, the furan polymer is further non-cross-linked.

Optionally, the method can further have at least any one of the following optional characteristics, which can possibly be used in association or alternatively:
the heat treatment can further comprise, before the annealing of the extruded thermosetting composite material, an intermediate annealing of the extruded thermosetting composite material, at at least an intermediate annealing temperature of between the extrusion temperature and the cross-linking temperature of the furan polymer, so as to evaporate at least partially the solvent of the thermosetting composite material before the cross-linking of the thermosetting matrix,
the intermediate annealing temperature can be between 40° C. and 90° C.,
the annealing temperature can be between 90° C. and 200° C., preferably between 100° C. and 150° C.,
during the extrusion, the thermosetting composite material can be extruded by a printing nozzle, the printing nozzle having a diameter of between 0.2 and 2 mm,
during the extrusion, the thermosetting composite material can be extruded at a speed of between 10 mm/s and 50 mm/s,
during the extrusion, the thermosetting composite material can be extruded under a pressure greater than 3 bar.

### BRIEF DESCRIPTION OF THE FIGURES

The aims, objective, as well as the characteristics and advantages of the different aspect of the invention will emerge best from the detailed description of particular embodiments of the latter, illustrated by the following accompanying drawings.

FIG. 1 represents an experimental mounting of an embodiment of the method according to the invention.

FIG. 2A represents the extrusion, according to an embodiment of the method according to the invention, of the thermosetting composite material according to an embodiment of the invention.

FIG. 2B represents the thermosetting composite material obtained from an intermediate annealing, according to an embodiment of the invention.

FIG. 2C represents the thermosetting composite material obtained from an annealing, according to an embodiment of the invention.

FIG. 3 represents the steps of the printing method according to an embodiment of the invention.

FIG. 4 represents the development of the temperature (in ° C.) over time (in minutes) during the heat treatment according to an embodiment of the method according to the invention.

FIG. 5 represents the development of the viscosity (in mPa·s) of the thermosetting composite material over time (in seconds) during the application of a shear gradient (amplitude on the right-hand y-axis indicated in s⁻¹).

FIG. 6 represents the development of the viscosity (in Pa·s) of the thermosetting composite material according to the shear rate (in s⁻¹).

The drawings are given as examples and are not limiting of the invention. They constitute principle schematic representations intended to facilitate the understanding of the invention, and are not necessarily to the scale of practical applications. In particular, the relative dimensions of the composite material and of the experimental mounting elements are not representative of reality.

### DETAILED DESCRIPTION

It is specified that in the scope of the present invention, the term “furan polymer” means a polymer family formed from the furfuryl alcohol monomer or its derivatives. From among the derivative of furfuryl alcohol, derivatives comprising a functional group, even a carbon chain, on the furan cycle can in particular be considered.

By “monomer unit”, this means a molecular structure repeated in a polymer, formed from a monomer. The polymers formed from one single monomer unit are called homopolymers. “Copolymer” is referred to when at least two monomer units, of different molecular structures, constitute the polymer.

According to an example, the term “furan polymer” means a polymer family comprising furan monomer units repeated n times, according to the following chemical formula, and where R and R′ can correspond to one from among a hydrogen H atom, a functional group and a carbon chain, the carbon chain could further comprise a functional group, R and R′ could be equal or different from one another.

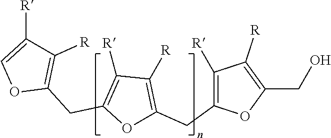

Furthermore, the furan polymer can be a copolymer comprising furan monomer units of different molecular structures, even the furan polymer can be a copolymer comprising furan monomer units and other non-furan monomer units, for example to modulate the vitreous transition temperature of the copolymer.

The word “biosourced” means materials of natural origin, and more specifically, which could come from biomass of animal or plant origin.

By compound or material “with the basis of” a material A, this means a compound or material comprising this material A, and possibly other materials.

Generally, a composite material is an assembly of at least two non-miscible materials, i.e. that the mixture of these materials does not form a homogenous phase. A composite material can, in particular, comprise a matrix and a non-miscible material with the matrix which could play the role of reinforcement and/or filler. The reinforcement is a material regaining mechanical forces in a composite material. The reinforcement can, in particular, form a framework within the composite material. The matrix mainly aims to transmit the mechanical forces to the reinforcement. The filler is a material enabling to modulate the properties and/or the cost of the composite material. The matrix thus ensures the protection of the reinforcement and/or of the filler against various environmental conditions. It further enables to give the desired shape to the object.

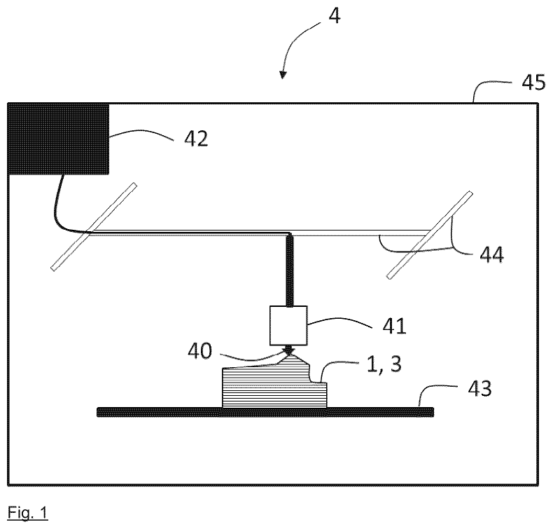

The thermosetting composite material 1 and the method 2 for 3D printing this material 1, according to particular embodiments of the invention, are now described in reference to FIGS. 1 to 4.

As illustrated in FIG. 1, the thermosetting composite material 1 can, in particular, be intended to be printed to form an object 3, for example in 3D, according to a method described in more detail below.

The thermosetting composite material 1 comprises a thermosetting matrix 10. This thermosetting matrix 10 is more specifically intended to be printed, for example, by paste extrusion, called LDM extrusion below. Printing by extrusion is simpler and less expensive than sintering techniques. The thermosetting composite material 1 is printable without having to be in the molten state, the thermosetting matrix 10 having a viscosity enabling LDM extrusion. It is however noted that other methods for shaping the thermosetting composite material 1 can be considered, which comprise, for example, a moulding step.

The thermosetting matrix 10 is a furan polymer. The transformation of the thermosetting matrix 10 to obtain the solid thermoset composite material 1′ is done by the at least partial cross-linking of the furan polymer. The cross-linking enables to form a three-dimensional macromolecular network in the at least partially cross-linked matrix 10′, and thus fix the shape of the object 3 by hardening the matrix. This cross-linking can, for example, be induced by a thermal annealing. The thermosetting composite material 1, and more specifically, the thermosetting matrix 10, can further comprise a cross-linking catalyst of the furan polymer. The furan polymer of the thermosetting matrix 10 preferably has a polymerisation degree of less than 10. Preferably, the furan polymer is further non-cross-linked. A low polymerisation degree, even the non-cross-linking of the furan polymer facilitates the implementation of the thermosetting composite material 1, for example, for its printing by extrusion, by limiting the risk of blocking the printing nozzle.

As stated above, this furan polymer family is formed from the furfuryl alcohol monomer or its derivatives. Furfuryl alcohol and its derivatives generally come from renewable resources, and more specifically, by hydrogenation of furfural, which is itself typically produced from biomass, for example from corn ears, sugarcane bagasse, and softwood.

The furfuryl alcohol monomer is liquid at ambient temperature and has a high solubility in water and in numerous organic solvents. Furthermore, its polymerisation can be done under flexible conditions. Furan polymers are commercially available and inexpensive, their price being typically a few euros per kilogram of polymers.

The proportion of furan polymer in the composite material 1 can be greater than 20% by mass. Preferably, the proportion of furan polymer is of between 50% and 70% by mass, with respect to the total mass of the composite material 1.

In order to enable the shaping of the thermosetting composite material 1, while enabling to obtain good properties of resistance to high temperatures of the object 3, the thermosetting composite material 10 comprises a non-miscible material 11 with the thermosetting matrix 10. Below, it is considered, in a non-limiting manner, that this material is a reinforcement 11, and therefore enables to improve the mechanical properties of the thermoset composite material 1′. It can absolutely be considered that this material 11 plays the role of a filler in the composite material 1, and thus enables to modulate the cost, even other properties of the thermoset composite material 1′.

This reinforcement 11 is more specifically formed of particles chosen from among micrometric particles, nanometric particles, even a mixture of micrometric particles and nanometric particles. Thus, the reinforcement further confers rheological properties to the thermosetting composite material 1, making it compatible with an LDM extrusion, in particular in terms of viscosity, shear-thinning and thixotropic behaviour. For example, a viscosity at a low shear rate of between 100 and 10000 Pa·s can be obtained.

The micrometric and/or nanometric size of the particles enables to limit the risk of blocking the instrument used for the printing of the thermosetting composite material 1. When the particles are nanometric, at least 50% of the particles have at least one dimension of between 1 and 100 nm. When the particles are micrometric, at least 50% of the particles have at least one dimension of between 1 and 100 μm.

These particles are with the basis of a compound comprising more than 40% by mass of carbon. Carbon-based particles are generally less abrasive than silica-based particles, and thus more compatible with a material extrusion, and in particular an LDM extrusion. The particles can be carbon particles, such as graphite, carbon black, graphene particles, carbon nanotubes or carbon nanofibres. These particles can be cellulose-based, even in particular sawdust-, fruit pip or shell-based, for example nuts or olives. When the particles are fruit pip or shell-based, they can be obtained by a grinding of these elements. The reinforcement 11 can thus be biosourced, and commercially available. When the particles are graphite, carbon black, cellulose-, sawdust- or fruit pip or shell-based, the reinforcement 11 is advantageously cheaper.

The cellulose-based particles can more specifically be chosen from among cellulose powder, and cellulose microfibrils, commonly called nanocellulose. The cellulose powder is a micrometric powder obtained from cellulose fibres, for example by grinding. The cellulose powder particles typically have a diameter of between 1 and 200 μm, even between 1 and 50 μm. More specifically, the size of the cellulose powder particles can be chosen according to the diameter of the printing nozzles.

It is known to form microfibrillated cellulose, also called by the name nanocellulose, from cellulose fibres. Microfibrillated cellulose is a heterogenic nanomaterial composed of elements of a micrometric size, cellulose fibre fragments, and of at least 50% by number of nanoobjects (i.e. objects of which at least one of the dimensions is between 1 and 100 nanometres). These cellulosic nanoobjects are called “microfibrils” or “microfibres”, MFC or CMF (“Cellulose MicroFibrils), “nanofibrils” or “nanofibres”, NFC or CNF (“Cellulose Nanofibrils”). Cellulose micro- or nanofibrils typically have a diameter of between 5 and 70 nm and a length of 0.5 to 5 μm.

The proportion of reinforcement 11 in the thermosetting composite material 1 can impact on its properties. According to the nature of the reinforcement 11, this proportion can further vary. The more the propagation of reinforcement 11 increases in the thermosetting composite material 1, the more its viscosity increases. This is therefore about limiting the proportion of reinforcement 11 in this material 11 in order to be able to print it by extrusion. It is however important to preserve a significant proportion of reinforcement 11 in the thermosetting composite material 1 in order to preserve good properties, resistant to high temperatures after cross-linking, even good mechanical properties.

During the development of the invention, it has been shown that when the particles are cellulose-based, and in particular cellulose powder-based, and nanocellulose-based, a better compromise between the viscosity and the properties of the thermoset composite material 1′ after cross-linking can be obtained for a proportion of the particles in the composite material 1 of between 15% and 40% by mass, preferably between 20% and 35%, and more specifically between 25% and 30%, with respect to the total mass of the composite material 1. A proportion between 25% and 30% enables to obtain a particularly homogenous thermosetting composite material.

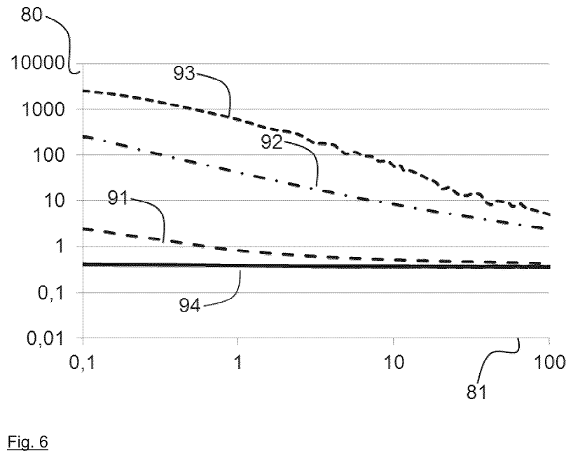

According to the example illustrated in FIG. 5, for a percentage of cellulose-based particles, and more specifically of cellulose powder, of between 10 and 25% (curves 91 to 93), a variation of viscosity 70 of the thermosetting composite material 1 can be observed during the application of a shear gradient 90 over time (in seconds) 71. According to the example illustrated in FIG. 6, a decrease of viscosity 80 (in Pa·s) of several thermosetting composite materials 1 (curves 91 to 93) according to the shear rate 81 (in s⁻¹) can be observed, while a material with no cellulose powder 94 behaves like a Newtonian fluid. Still according to this example, the shear-thinning behaviour increases with the proportion of cellulose powder in the thermosetting composite material 1 at least for a range of between 10 and 25%. Thus, the flow index passes from 0.7 for a proportion of 10% of cellulose powder to 0.04 for a proportion of 25% of cellulose powder.

When the particles are sawdust-based, the proportion of particles in the thermosetting composite material 1 is of between 10% and 80% by mass, preferably between 15% and 60%, and more preferably, between 20% and 40%, with respect to the total mass of the composite material 1. When the particles are carbon particles, the proportion of particles in the thermosetting composite material 1 is of between 1% and 80% by mass, preferably between 10% and 70%, and more preferably between 40% and 60%, with respect to the total mass of the composite material 1.

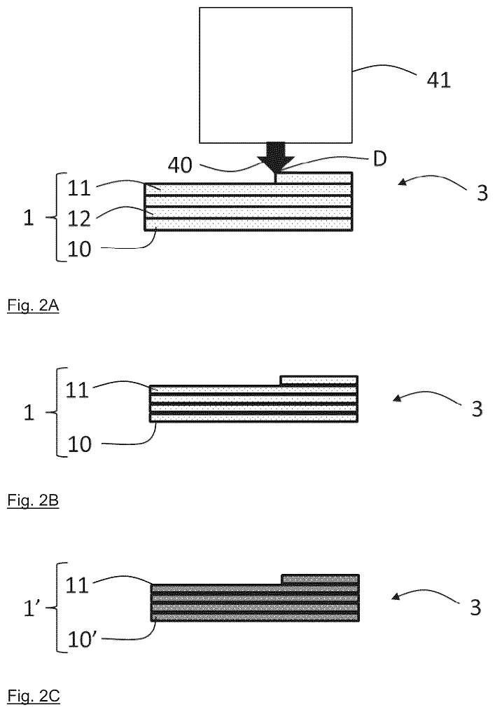

The thermosetting composite material 1 further comprises a solvent 12. The solvent 12 can compensate for a significant proportion of reinforcement 11, by facilitating the extrusion of the material 1. In particular, the solvent 12 decreases the viscosity of the thermosetting composite material 1. During the cross-linking of the thermosetting matrix 10, the solvent 12 is at least partially evaporated so as to improve the mechanical properties of the object 3. Preferably, the solvent 12 is totally evaporated. During this evaporation, a too large proportion of solvent 12 with respect to the proportions of the matrix 10 and of the reinforcement 11 can lead to a significant removal of the material 1. This phenomenon of removal during the evaporation of the solvent can be illustrated by the decrease of thickness of the layers of deposited thermosetting composite material 1, between FIG. 2A and FIG. 2C. This removal can induce defects such as cracks in the thermoset composite material 1′, and therefore decrease its mechanical properties.

The proportion of the solvent 12 in the thermosetting composite material 1 can be of between 5% and 25% by mass, preferably between 10% and 20%, with respect to the total mass of the composite material 1. By reducing the proportion of solvent 12 in the thermosetting composite material 1 in the ranges indicated, the dimensional tolerances can pass from a range of between 2.5 and 8% to a range of between 2.5 and 5%. Surprisingly, it has been highlighted during the development of the composite material that this range of proportions of the solvent does not induce the significant increase of the removal of the thermosetting composite material 1 during its cross-linking, while limiting the viscosity of the thermosetting composite material 1. Indeed, the reinforcement 11 in the proportions stated above can induce a contact between the particles of the reinforcement 11 in the thermosetting composite material 1. This contact between the particles of the reinforcement 11 enables to guide the evaporation of the solvent 12 through the thermosetting composite material 1. The defects in the object 3 made of thermoset composite material 1′ are subsequently minimised. The synergy between the solvent 12 and the reinforcement 11 therefore facilitates the implementation of the thermosetting composite material 1, for example for its printing by extrusion, while limiting the risk of deterioration of the printed object 3.

The evaporation of the solvent 12 can be induced by a heat treatment of the thermosetting composite material 1. It is preferable to be able to limit the heating temperature, in order to limit the cost of the printing method and to limit, even to avoid, a degradation of the material 1. For this, the solvent 12 can have a boiling point of less than 150° C. Furthermore, the solvent 12 can have a flashpoint temperature of greater than 50° C., in order to avoid damaging the thermosetting composite material 1 during the heat treatment.

The solvent 12 can, for example, be chosen from among water, ethanol, isopropanol, or also a mixture of at least two of these solvents. Thus, the solvent 12 or the solvent mixture has a low toxicity. The environmental impact of the thermosetting composite material 1 is therefore reduced. Ethanol or isopropanol can further increase the removal speed of the solvent with respect to a solvent 12 only comprising water.

The thermosetting composite material 1 according to the characteristics stated above can be totally biosourced, and printable by extrusion. It is understood that this thermosetting composite material represents a biosourced alternative to synthetic thermoplastic polymers. Furthermore, the cost of the thermosetting composite material 1 can be less than a factor, twenty to sixty to that of synthetic polymers, and for example to that of PEEK. Synthetic thermoplastic polymers typically have a cost of between €250 and €600 per kg. According to the particular embodiment where the thermos-compressive composite material 1 comprises a reinforcement 11 of cellulose powder and wherein the solvent is water, its cost is, as a maximum, €10 per kg.

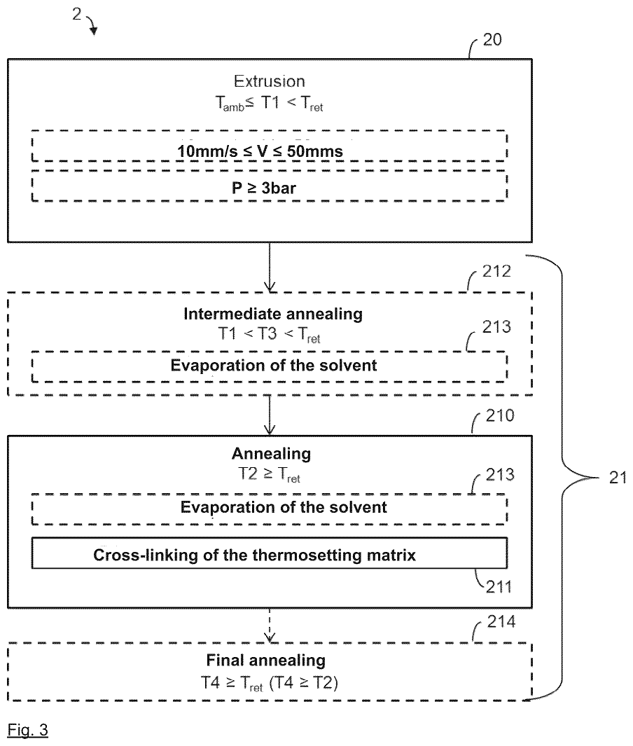

The method 2 for the 3D printing of an object 3 according to an embodiment of the invention is now described in reference to FIGS. 1 to 4. The method 2 can more specifically implement the thermosetting composite material 1 according to the characteristics stated above. As an example, the method according to an embodiment is illustrated by FIG. 3, where optional steps of the method are indicated as a dotted line.

The method 2 first comprises the extrusion 20 of the thermosetting composite material 1, could be called an LDM extrusion. The method 2 further comprises a heat treatment 21, comprising an annealing 210 of the thermosetting composite material 1, so as to fix the shape of shape of an object 3 formed during the extrusion step 20.

According to the experimental mounting 4 example illustrated in FIG. 1, the thermosetting composite material 1 can be stored in a reservoir 42. The thermosetting composite material 1 can be conveyed to an extruder 41, this extruder 41 comprising at least one printing nozzle 40. The extruder 41 can further be disposed on rails 44 enabling its movement in a plane parallel to the printing bed 43. The extruder 41 can further be configured to move in translation in a direction perpendicular to the printing bed 43. Thus, an object 3 can be printed in 3D, by the deposition of successive layers of the thermosetting composite material 1. A part, even all, of these elements can further be contained in a thermostatic printing chamber 45, so as to regulate the temperature of the steps of the method 2.

The thermosetting composite material 1 is extruded 20 at an extrusion temperature T1 greater than or equal to the ambient temperature T_{amb} and less than the cross-linking temperature Tᵣₑₜ of the furan polymer. Thus, the risk of blocking of the printing nozzles is limited, even avoided. For this, preferably, the extrusion is done at the ambient temperature or at a temperature less than 40° C.

As illustrated by FIG. 2A, the thermosetting composite material 1 comprising the thermosetting matrix 10, the reinforcement 11 and the solvent 12 can be extruded by a printing nozzle 40. The thermosetting composite material 1 can be printed by a printing nozzle 40 having a diameter D of between 0.2 and 2 mm. The thermosetting composite material 1 can therefore be printed by commercial 3D printers, without requiring any printing nozzle particularly adapted to this material 1. For example, the thermosetting composite material 1 can be printed by a commercial 3D printer with an extruder 41 comprising a compressed air screw conveyor for the LDM extrusion of the material 1.

Preferably, the thermosetting composite material 1 is extruded at a speed V of between 10 mm/s and 50 mm/s. A rapid printing of the thermosetting composite material 1 is indeed possible, and this, in particular thanks to its rheological properties, and in particular in terms of viscosity, shear-thinning and thixotropic behaviour. The thermosetting composite material 1 can further be extruded under a pressure P greater than 3 bar (equivalent to 3000 hPa, in the basic units of the international system).

In order to fix the shape of the 3D object formed during the extrusion step 20, the heat treatment 21 comprises an annealing 210 of the thermosetting composite material 1, at an annealing temperature T2 greater than or equal to the cross-linking temperature Tᵣₑₜ of the furan polymer, so as to induce an at least partial cross-linking 211 of the thermosetting matrix 10. The annealing temperature T2 can be of between 90° C. and 200° C., and preferably between 100° C. and 150° C. During the annealing 210, the evaporation 213 of the solvent 12 can further occur, as illustrated in the passage of FIG. 2A to FIG. 2C. The cross-linking reaction 211 is generally exothermal, and can induce a degassing and an evaporation 213 of the solvent 12.

The heat treatment 21 can further comprise, prior to the annealing 210, an intermediate annealing 212 of the thermosetting composite material 1, so as to at least partially evaporate 213 the solvent 12 of the thermosetting composite material 1 before the cross-linking 211 of the thermosetting matrix 10. The solvent 12, as well as possible gases present in the material are thus at least partially removed before the cross-linking 211 of the thermosetting matrix 10, according to the example illustrated by the passage of FIG. 2A to FIG. 2B. The risk of fracture, defect, even breaking in the thermoset composite material 1′ is also minimised. For this, the intermediate annealing 212 can be done at at least one intermediate annealing temperature T3 of between the extrusion temperature T1 and the cross-linking temperature Tᵣₑₜ of the furan polymer. Preferably, the intermediate annealing temperature T3 is greater than or equal to the evaporation temperature of the solvent 12. More preferably, the intermediate annealing temperature T3 can be of between 40° C. and 110° C., even between 40 and 90° C.

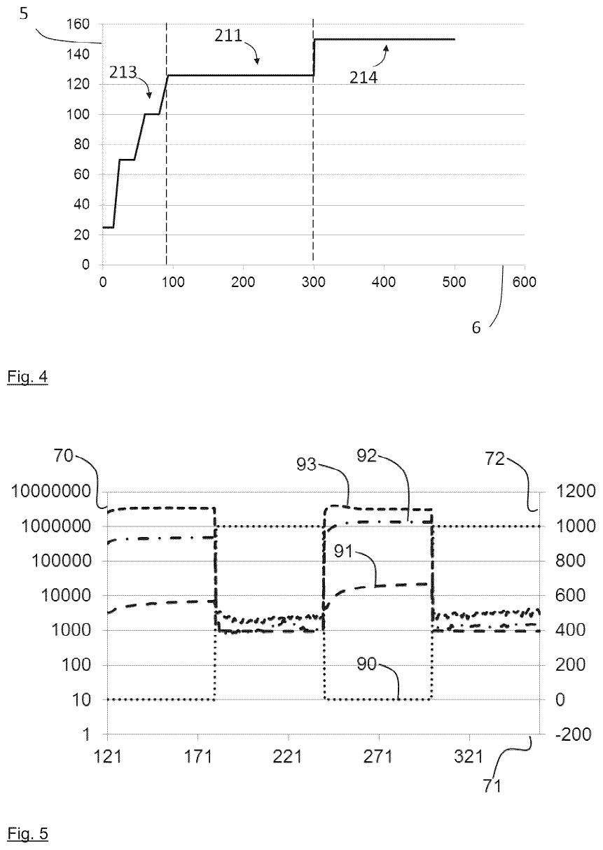

Preferably, the extrusion 20 temperature T1, the at least one intermediate annealing 212 temperature T3 and the annealing temperature T2 are chosen so as to form a ramp, progressively increasing in temperature, in order to minimise the thermal shocks on the composite material and also minimise the risk of fracture, defect, even breaking. As an example, FIG. 4 describes the development of temperature (in ° C.) 5 of the heat treatment 21 over time (in minutes) 6, according to a particular embodiment of the method 2. The heat treatment 21 can comprise an intermediate annealing 212, comprising three temperature stages T3 at 25° C., 70° C. and 100° C., during which the thermosetting composite material progressively increases in temperature and the evaporation 213 of the solvent occurs. Then, the heat treatment 21 can comprise an annealing 212 at a temperature T2 of around 125° C., so as to induce the at least partial cross-linking 211 of the thermosetting matrix 10. This annealing can be accompanied by a final annealing 214 at a temperature T4 greater than the cross-linking temperature Tᵣₑₜ of the furan polymer, and preferably greater than the temperature T2 of the annealing, for example at a temperature of 150° C., to guarantee and/or accelerate a complete cross-linking of the matrix 10′. It is noted that with a temperature of 110° C., a complete cross-linking of the material 10′ can be reached, for example in 40 to 60 minutes.

Different alternatives can be considered for the heat treatment 21. To minimise as much as possible the defects in the thermoset composite material 1′, it is preferable to perform all of the heat treatment 21 in the printing chamber 45. However, this can decrease the efficiency of the method 2 by occupation of the printing chamber 45. The intermediate annealing 212 and the annealing 210 can be done in the printing chamber 45, to obtain the partially cross-linked thermoset composite material 1′. Subsequently, the thermoset composite material 1′ is partially fixed by hardening and is thus more easily transportable, for example to an annealing furnace to finalise the cross-linking 211 during a final annealing 214. The effectiveness of the method 2 is thus improved. Furthermore, the intermediate annealing 212 can be done at least partially simultaneously to the extrusion 20 of the thermosetting composite material 1, in order to increase the efficiency of the method 2.

It is noted that the durations and the temperatures of the heat treatment 21 can be optimised according, for example, to the composition of the thermosetting composite material 1, and of the size of the object and also of the quantity of catalyst added. In particular, too-intense treatments can induce the generation of porosity and the cracking of the material.

The invention is not limited to the embodiments described above and extends to all the embodiments covered by the claims.

In particular, it can be considered that the thermosetting composite material comprises at least one additive.

### LIST OF REFERENCES

1 Thermosetting composite material
1′ Thermoset composite material
10 Thermosetting matrix
10′ At least partially cross-linked matrix
11 Reinforcement
12 Solvent
2 Method
20 Extrusion
21 Heat treatment
210 Annealing
211 Cross-linking of the thermosetting matrix
212 Intermediate annealing
213 Evaporation of the solvent
214 Final annealing
3 Object
4 Experimental mounting
40 Printing nozzle
41 Extruder
42 Reservoir
43 Printing bed
44 Rail
45 Thermostatic printing chamber
5 Temperature (° C.)
6 Time (minutes)
70 Viscosity (mPa·s)
71 Time (seconds)
72 Shear rate (s⁻¹)
80 Viscosity Pa·s
81 Shear rate s⁻¹
90 Shear gradient
91 Thermosetting composite material comprising 10% of cellulose powder of diameter of 10 μm
92 Thermosetting composite material comprising 20% of cellulose powder of diameter of 10 μm
93 Thermosetting composite material comprising 25% of cellulose powder of diameter of 10 μm
94 Thermosetting composite material comprising 0% of cellulose powder of diameter of 10 μm
D Diameter of the printing nozzle
T1 Extrusion temperature
T2 Annealing temperature
T3 Intermediate annealing temperature
T4 Final annealing temperature
T_{amb} Ambient temperature
Tᵣₑₜ Cross-linking temperature

1. A thermosetting composite material for 3D printing comprising:
a furan copolymer or homopolymer, formed from furfuryl alcohol monomer or its derivatives, and forming a thermosetting matrix of the composite material, and
a non-miscible material with the thermosetting matrix,
wherein that the thermosetting composite material further comprises a solvent, and in that the non-miscible material with the thermosetting matrix is formed of particles chosen from among:
micrometric particles, at least 50% of the micrometric particles having at least one dimension of between 1 and 100 m,
nanometric particles, at least 50% of the nanometric particles having at least one dimension of between 1 and 100 nm, and
a mixture of said micrometric particles and nanometric particles,
the particles being with the basis of a compound comprising more than 40% by mass of carbon, and are chosen from among graphite, carbon black, graphene particles, carbon nanotubes and carbon nanofibres, a micrometric cellulose powder, nanocellulose, and particles with the basis of one from among sawdust and fruit pips or shells,
when the particles are chosen from among graphite, carbon black, graphene particles, carbon nanotubes or carbon nanofibres, the proportion of particles in the thermosetting composite material is of between 10% and 70% with respect to the total mass of the composite material,
when the particles are chosen from among a micrometric cellulose powder and nanocellulose, the proportion of particles in the thermosetting composite material is of between 15% and 40% by mass, with respect to the total mass of the composite material,
when the particles are with the basis of one from among sawdust, fruit pips and shells, the proportion of particles in the thermosetting composite material is of between 10% and 80% by mass, with respect to the total mass of the composite material.

2. The thermosetting composite material according claim 1, wherein, when the particles are chosen from among a micrometric cellulose powder and nanocellulose, the proportion of particles in the thermosetting composite material is of between 20% and 35%, and more preferably, between 25% and 30%, with respect to the total mass of the composite material.

3. The thermosetting composite material according to claim 1, wherein, when the particles are with the basis of one from among sawdust, fruit pips and shells, the proportion of particles in the thermosetting composite material is of between 15% and 60%, and more preferably between 20% and 40%, with respect to the total mass of the composite material.

4. The thermosetting composite material according to claim 1, wherein, when the particles are carbon particles, the proportion of particles in the thermosetting composite material (1) is of between 40% and 60%, with respect to the total mass of the composite material.

5. The thermosetting composite material according to claim 1, wherein the proportion of the solvent in the thermosetting composite material is of between 5% and 25% by mass, preferably between 10% and 20%, with respect to the total mass of the composite material.

6. The thermosetting composite material according to claim 1, wherein the solvent has at least one from among a boiling point of less than 150° C. and a flashpoint temperature of greater than 50° C.

7. The thermosetting composite material according to claim 1, wherein the solvent is chosen from among water, ethanol, isopropanol and a mixture of at least two from among water, ethanol and isopropanol.

8. The thermosetting composite material according to claim 1, wherein the proportion of the furan polymer in the thermosetting composite material is greater than 20% by mass, preferably the proportion of the furan polymer is of between 50% and 70% by mass, with respect to the total mass of the composite material.

9. The thermosetting composite material according to claim 1, wherein the furan polymer has a polymerisation degree of less than 10, and preferably the furan polymer is non-cross-linked.

10. An use of a thermosetting composite material according to claim 1, for 3D printing by extrusion.

11. A method for the 3D printing of an object, comprising:
an extrusion of a thermosetting composite material according to claim 1,
wherein the thermosetting composite material is extruded at an extrusion temperature greater than or equal to the ambient temperature T_{amb} and less than the cross-linking temperature Tᵣₑₜ of the furan polymer, and
a heat treatment comprising an annealing of the extruded thermosetting composite material, at an annealing temperature T2 greater than or equal to the cross-linking temperature Tᵣₑₜ) of the furan polymer, so as to induce an at least partial cross-linking of the thermosetting matrix to form an object in a thermoset composite material comprising an at least partially cross-linked matrix.

12. The method according claim 11, wherein the heat treatment further comprises, before the annealing of the extruded thermosetting composite material, an intermediate annealing of the extruded thermosetting composite material, at at least one intermediate annealing temperature T3 of between the extrusion temperature T1 and the cross-linking temperature Tᵣₑₜ of the furan polymer, so as to at least partially evaporate the solvent of the thermosetting composite material before the cross-linking of the thermosetting matrix.

13. The method according claim 12, wherein, the intermediate annealing temperature T3 is of between 40° C. and 90° C.

14. The method according to claim 11, wherein, the annealing temperature T2 is of between 90° C. and 200° C., preferably between 100° C. and 150° C.

15. The method according to claim 11, wherein, during the extrusion, the thermosetting composite material is extruded by a printing nozzle, the printing nozzle having a diameter of between 0.2 and 2 mm.

16. The method according to claim 11, wherein, during the extrusion, the thermosetting composite material is extruded at a speed V of between 10 mm/s and 50 mm/s.

17. The method according to claim 11, wherein, during the extrusion, the thermosetting composite material is extruded under a pressure greater than 3 bar.
